SEQUENCE LISTING (7 sequences)

SEQ ID NO: 1 - DNA, 670 bp, Artificial sequence
  template sta-atii
cggcatatgatcccgcgaaattaatacgactcactatagggagaccacaacggtttccctctagaaggagccgccaccatggctagcatgactggtggacagcaaatgggtcgggaccaggctggcatcaccggcacctggtacaaccagctcggctcgaccttcatcgtgaccgcgggcgccgacggcgccctgaccggaacctacgagtcggccgtcggcaacgccgagagccgctacgtcctgaccggtcgttacgacagcgccccggccaccgacggcagcggcaccgccctcggttggacggtggcctggaagaataactaccgcaacgcccactccgcgaccacgtggagcggccagtacgtcggcggcgccgaggcgaggatcaacacccagtggctgctgacctccggcaccaccgaggccaacgcctggaagtccacgctggtcggccacgacaccttcaccaaggtgaagccgtccgccgcctccatcgacgcggcgaagaaggccggcgtcaacaacggcaacccgctggacgctgttcagcagtacccaggatcaggcggcggtggttccggtggtggcggctctggaggtggaggcagcggtggaggtggcgaccgggtgtacatacaccccttctaaccgctgagcaataactagc

SEQ ID NO: 2 - DNA, 28 bp, Artificial sequence
  primer T7F
cggcatatgatcccgcgaaattaatacg

SEQ ID NO: 3 - DNA, 19 bp, Artificial sequence
  primer T7R
gctagttattgctcagcgg

SEQ ID NO: 4 - DNA, 604 bp, Artificial sequence
  template sta-avp
cggcatatgatcccgcgaaattaatacgactcactatagggagaccacaacggtttccctctagaaggagccgccaccatggctagcatgactggtggacagcaaatgggtcgggaccaggctggcatcaccggcacctggtacaaccagctcggctcgaccttcatcgtgaccgcgggcgccgacggcgccctgaccggaacctacgagtcggccgtcggcaacgccgagagccgctacgtcctgaccggtcgttacgacagcgccccggccaccgacggcagcggcaccgccctcggttggacggtggcctggaagaataactaccgcaacgcccactccgcgaccacgtggagcggccagtacgtcggcggcgccgaggcgaggatcaacacccagtggctgctgacctccggcaccaccgaggccaacgcctggaagtccacgctggtcggccacgacaccttcaccaaggtgaagccgtccgccgcctccatcgacgcggcgaagaaggccggcgtcaacaacggcaacccgctggacgctgttcagcagtgctacttccagaactgcccgaggggctaaccgctgagcaataactagc

SEQ ID NO: 5 - DNA, 41 bp, Artificial sequence
  primer ATF
ggaattcgccaccatgattctcaactcttctactgaagatg

SEQ ID NO: 6 - DNA, 33 bp, Artificial sequence
  primer ATR
gcaccatgttttgaggttgagttatctagacgg

SEQ ID NO: 7 - protein, 5 aa, Artificial sequence
  Synthetic peptide
GRGDS

(19) United States
(12) Patent Application Publication
(10) Pub. No.: US 2006/0210982 A1
(43) Pub. Date: Sep. 21, 2006

(54) Cleavable assigned molecules and screening method using the same

(76) Inventors: Hiroshi Yanagawa, YOKOHAMA-SHI (JP); Nobuhide Doi, Yokohama-shi (JP); Tetsuya Nagano, Yokohama-shi (JP); Hideaki Takashima, Yokohama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/543,682

(22) PCT Filed: Feb. 2, 2004
(86) PCT No.: PCT/JP04/01004

§ 371 Date: Jul. 28, 2005

(30) Foreign Application Priority Data
Jan. 31, 2003 (JP) 2003-023228

(51) Int. Cl. C40B 40/08

(52) U.S. Cl. 435/6; 536/23.1

(57) ABSTRACT

A method for screening a nucleic acid library for a nucleic acid encoding a protein that interacts with a target substance, which comprises: the step of producing a library of assigning molecules each comprising a protein and a nucleic acid encoding the protein linked to each other via a linker cleavable under a condition that does not change a nucleotide sequence of the nucleic acid; the step of mixing the library of assigning molecules and the target substance; the step of separating an assigning molecule binding to the target substance; the step of cleaving a linker of the separated assigning molecule under a condition that does not change a nucleotide sequence of the nucleic acid to release the nucleic acid; and the step of collecting the released nucleic acid. By this method, screening for an assigning molecule that specifically binds to a target substance can be conducted with high efficiency.

### TECHNICAL FIELD

The present invention relates to an assigning molecule and a screening method utilizing the same.

### BACKGROUND ART

In the evolutionary molecular engineering or genome functional analysis, application of in vitro selection of a protein is expected for efficient selection of a nucleic acid encoding an unknown protein that interacts with a biological molecule such as a protein or nucleic acid from a nucleic acid library derived from any of various organisms and tissues or an artificially synthesized nucleic acid library. In order to realize in vitro selection of a protein, a method of using a molecule obtained by linking a protein (phenotype) and a nucleic acid (genotype) encoding the protein has been proposed. Because a phenotype and a genotype are assigned to each other by linking of a protein and a nucleic acid encoding the protein in this molecule, it is called an assigning molecule. As assigning molecules, those based on the STABLE method (Patent document 1, Non-patent document 1) and those based on the in vitro virus method (Patent document 2, Non-patent document 2, Patent document 3) are known.

In vitro selection of a protein that interacts with a target substance such as a biological molecule is attained by binding the protein with the target substance immobilized on a solid phase and then collecting the binding protein. In this selection method, existence of proteins nonspecifically binding to the solid phase or the target substance greatly influence on the selection efficiency, and therefore methods of decreasing contaminating molecules due to nonspecific binding have been proposed. For example, for the case where the target substance is a protein, the tandem affinity purification method is known (Non-patent document 3). In this method, a fusion protein comprising a target protein fused with a calmodulin binding protein, a cleavage site for a sequence-specific protease and an IgG binding domain (ZZ domain) of protein A on the C-terminus side of the target protein is used. In the first screening step, the fusion protein is immobilized by adsorption and binding of the ZZ domain of the fusion protein to IgG-bound beads, and a complex containing the target protein and the protein binding thereto is eluted by cleavage with a sequence-specific protease. In the second screening step, the fusion protein is immobilized on calmodulin-immobilized beads by binding the calmodulin binding protein of the fusion protein with the calmodulin-immobilized beads, and a complex containing the target protein and the protein binding thereto is eluted with a calcium chelating agent such as EDTA.
<Non-patent document 1>
FEBS Lett., 457, 227 (1999)
<Patent document 1>
Japanese Patent Laid-open (Kokai) No. 2001-128690
<Patent document 2>
International Publication No. WO98/16636
<Non-patent document 2>
FEBS Lett., 414, 405 (1997)
<Patent document 3>
International Publication No. WO02/48347
<Non-patent document 3>
Nat. Biotechnol., 17, 1030 (1999)

### DISCLOSURE OF THE INVENTION

When the substance to be screened is the assigning molecule, a nucleic acid is binding to a protein in the molecule. Therefore, an assigning molecule that does not specifically bind to a target substance may also be retrieved due to nonspecific binding of the nucleic acid with a solid phase or the target substance other than the interaction between the protein and the target substance. Therefore, for the case of using the assigning molecule, it is desired to provide a method for decreasing nonspecific contaminating molecules based on a principle different from that of the conventional methods.

Thus, an object of the present invention is to provide a method for screening assigning molecules, which decreases contamination of assigning molecules nonspecifically binding to a solid phase or a target substance, and enables highly efficient screening for an assigning molecule specifically binding to the target substance.

The inventors of the present invention conducted various researches with paying attention to the fact that, when assigning molecules are screened in the evolutionary molecular engineering or genome functional analysis, a portion of nucleic acid is used in the subsequent steps. As a result, they found that the aforementioned problem concerning screening of assigning molecules could be solved by linking a protein and a nucleic acid encoding the protein via a particular linker and cleaving the linker to release only the nucleic acid, and thus accomplished the present invention.

The present invention provides the followings.
(1) An assigning molecule comprising a protein and a nucleic acid encoding the protein linked to each other via a linker cleavable under a condition that does not change a nucleotide sequence of the nucleic acid.
(2) The assigning molecule according to (1), wherein the linker is a linker cleavable with long-wave ultraviolet light.
(3) A library of assigning molecules, each of which is the assigning molecule as defined in (1) or (2).
(4) A method for producing the assigning molecule as defined in (1), which comprises providing a nucleic acid encoding a protein constructed so that, when the nucleic acid is transcribed and/or translated, a translated protein and the nucleic acid is linked and transcribing and/or translating the prepared nucleic acid using a cell-free protein synthesis system or a live cell to prepare the assigning molecule comprising the protein and the nucleic acid linked to each other,

wherein the nucleic acid is constructed so that, when the nucleic acid is transcribed and/or translated, the protein and the nucleic acid is linked via a linker cleavable under a condition that does not change a nucleotide sequence of the nucleic acid.
(5) The method for producing a library of assigning molecules, which comprises producing the assigning molecules from nucleic acids constituting a nucleic acid library by the method as defined in (4).
(6) A method for screening a nucleic acid library for a nucleic acid encoding a protein that interacts with a target substance, which comprises:

the step of producing a library of assigning molecules from the nucleic acid library by the method as defined in (5),

the step of mixing the library of assigning molecules and the target substance,

the step of separating an assigning molecule binding to the target substance,

the step of cleaving a linker of the separated assigning molecule under a condition that does not change a nucleotide sequence of the nucleic acid to release the nucleic acid, and

the step of collecting the released nucleic acid.

### BRIEF EXPLANATION OF THE DRAWINGS

FIG. 1 is an explanatory diagram of a screening method utilizing an assigning molecule containing a cleavable linker.

FIG. 2 is an explanatory diagram of a method for releasing a genotype molecule from an assigning molecule by irradiation of long-wave ultraviolet light (excitation peak: 365 nm).

FIG. 3 (electrophoresis photograph) shows results of experiments of releasing a genotype molecule from an assigning molecule by irradiation of long-wave ultraviolet light. Lanes 1 to 6 represent the results obtained by using a fluorescein- and PCB-labeled DNA. Lanes 7 to 12 represent the results obtained by using a fluorescein- and biotin-labeled DNA.

FIG. 4 (electrophoresis photograph) shows results of electrophoretic confirmation of formation of an assigning molecule of PCB-labeled DNA in a cell-free transcription and translation system. Lane 1 represents the result for the case where an assigning molecule is formed. Lane 2 represents the result for the case where protein synthesis was inhibited so that any assigning molecule should not be formed.

FIG. 5 (electrophoresis photograph) shows results of experiments of binding hAT1R/CHO-K1 cells and STA-AT II assigning molecules and eluting sta-atii DNA as a genotype molecule by irradiation of long-wave ultraviolet light. Lanes 1 and 3 represent the results obtained by using hAT1R/CHO-K1 cells, and Lanes 2 and 4 represent the results obtained by using Mock/Cho-K1 cells. Further, Lane 5 represents the result for Sample A before the binding procedure.

### BEST MODE FOR CARRYING OUT THE INVENTION

Hereafter, the present invention will be explained in more detail. The disclosures of all the references cited in the present specification are incorporated into the present specification by reference.

<1> Assigning Molecule of the Present Invention

The assigning molecule of the present invention is characterized by containing a protein and a nucleic acid encoding the protein linked via a linker that can be cleaved under a condition that does not change the nucleotide sequence of the nucleic acid (also called a “cleavable linker” in this specification) . The assigning molecule of the present invention may have the same configuration as that of a usual assigning molecule except that it contains a protein and a nucleic acid encoding the protein linked via a cleavable linker.

The same shall apply to the library of assigning molecules. That is, it can be prepared according to a usual method for preparing a library of assigning molecules except that the assigning molecules of the present invention are used as assigning molecules. For example, in the evolutionary molecular engineering, a library of assigning molecules can be prepared by using a library constructed by the error-prone PCR (Leung, D. W., et al. (1989) J. Methods Cell Mol. Biol., 1, 11-15), sexual PCR (Stemmer, W. P. C. (1994) Proc. Natl. Acad. Sci. USA 91, 10747-10751), DNA shuffling, mutant library (Hiroshi Yanagawa, Toru Tsuji, “METHOD OF CONSTRUCTING MUTANT DNA LIBRARY AND UTILIZATION THEREOF”, WO02/26964) or the like as a template, and in the genome functional analysis, a library of assigning molecules can be prepared by using a cDNA library constructed by random priming or dT priming as a template.

<1-1> Configuration other than Cleavable Linker in Assigning Molecule

The nucleic acid may be either a DNA or RNA depending on the type of the assigning molecule. Further, the protein may be used as a fusion protein depending on the type of the assigning molecule.

The expression that “a protein and a nucleic acid are linked” also means that a protein and a nucleic acid are linked via another molecule, and the linkage between them may be any of covalent bond and non-covalent bonds such as a bond obtained by affinity of a biological molecule. Examples of the bond obtained by affinity of a biological molecule include a bond between an antigen and an antibody, a bond between a hormone and a receptor, a bond between a DNA and a DNA binding protein, and so forth.

Examples of the assigning molecule include those obtained by the STABLE method (Patent document 1, Non-patent document 1), and those obtained by the in vitro virus method (Patent document 2, Non-patent document 2, WO03/062417, WO98/31700). Hereafter, specific examples will be explained.

(a) Assigning Molecule Based on STABLE Method

The assigning molecule based on the STABLE method is constituted by a fusion protein of a protein (targeted protein) as an object of functional analysis, functional modification or the like and an adapter protein, and a DNA encoding the fusion protein and bound with a ligand, which are linked via binding of the adapter protein and the ligand.

The targeted protein may be either a natural protein or a mutant thereof, or an artificial protein or a mutant thereof. Natural proteins include a library of diverse proteins transcribed and translated from a cDNA library derived from any of organs, tissues and cells of various organisms. Artificial proteins include a sequence of a combination including an entire or partial sequence of a natural protein, or a random amino acid sequence.

The adapter protein means a protein having an ability to specifically bind to a certain molecule (ligand), and includes a binding protein, a receptor protein constituting a receptor, an antibody and so forth. The ligand means a molecule that specifically binds to the adapter protein. Examples of the combination of adapter protein/ligand include, for example, biotin binding protein such as avidin and streptavidin/biotin, maltose binding protein/maltose, G-protein/guanine nucleotide, polyhistidine peptide/metal ion such as nickel or cobalt ion, glutathione S-transferase/glutathione, DNA binding protein/DNA, antibody/antigen molecule (epitope), calmodulin/calmodulin binding peptide, ATP binding protein/ATP, any of various receptor protein/ligand thereof such as estradiol receptor protein/estradiol, and so forth.

Among these, as the combination of the adapter protein/ligand, biotin binding protein such as avidin and streptavidin/biotin, maltose binding protein/maltose, polyhistidine peptide/metal ion such as nickel or cobalt ion, glutathione S-transferase/glutathione, antibody/antigen molecule (epitope) and so forth are preferred, and the combination of streptavidin/biotin is most preferred.

The DNA encoding a fusion protein used in this embodiment is usually bound with a ligand at one end. Via a bond between the ligand binding to the end of the DNA and the adapter protein portion in the fusion protein expressed by the DNA, the fusion protein and the DNA are physically linked.

The assigning molecule of this embodiment can be produced by expressing a DNA having at least a transcription and translation initiation region and a region encoding a fusion protein of targeted protein and adapter protein, and bound with a ligand in a cell-free transcription and translation system to synthesize a protein. Preferably, the assigning molecules are produced by expressing a library of DNAs each having at least a transcription and translation initiation region and a region encoding a fusion protein of targeted protein and adapter protein, and bound with a ligand in cell-free transcription and translation systems separated so that each system should contain one kind or one molecule of DNA among the DNAs in the library to synthesize proteins.

(b) Assigning Molecule Based on In Vitro Virus Method

The assigning molecule based on the in vitro virus method comprises a phenotype molecule containing a protein as an object of functional analysis, functional modification or the like and a genotype molecule containing a nucleic acid encoding the protein linked to each other. The genotype molecule comprises a coding molecule having a region encoding a protein in such a manner that the nucleotide sequence of the region can be translated and a spacer molecule linked to each other.

The spacer molecule used in this embodiment contains a donor region that can bind to the 3′ end of the nucleic acid, a PEG region containing polyethylene glycol as a main component and binding to the donor region, and a peptide acceptor region binding to the PEG region and containing a group that can bind to a peptide by a transpeptidation reaction. The spacer molecule may not contain the PEG region.

The donor region that can bind to the 3′ end of the nucleic acid usually consists of one or more nucleotides. The number of nucleotides is usually 1 to 15, preferably 1 to 2. The nucleotides may be a ribonucleotide or a deoxyribonucleotide.

The sequence of the 5′ end of the donor region affects the ligation efficiency. In order to attain ligation of the coding molecule and the spacer molecule, it is required to include at least one or more residues, and at least one residue of dC (deoxycytidylic acid) or two residues of dCdC (dideoxycytidylic acid) is preferred for an acceptor having a poly-A sequence. As for the type of nucleotide, preference is higher in the order of C>(U or T)>G>A.

The PEG region contains polyethylene glycol as a main component. The expression “contains polyethylene glycol as a main component” used herein means that the total number of nucleotides contained in the PEG region is 20 or less, or the average molecular weight of the polyethylene glycol is 400 or more. It preferably means that the total number of nucleotides is 10 or less, or the average molecular weight of the polyethylene glycol is 1000 or more.

The average molecular weight of the polyethylene glycol in the PEG region is usually 400 to 30,000, preferably 1,000 to 10,000, more preferably 2,000 to 8,000. If the molecular weight of the polyethylene glycol is lower than about 400, a posttreatment for assignment translation may be required for assignment translation of a genotype molecule containing a spacer portion derived from such a spacer molecule (Liu, R., Barrick, E., Szostak, J. W., Roberts, R. W. (2000) Methods in Enzymology, vol. 318, 268-293). However, if PEG having a molecular weight if 1000 or more, preferably 2000 or more, is used, highly efficient assignment can be attained only by assignment translation, and therefore the posttreatment for the translation becomes unnecessary. Further, when the molecular weight of the polyethylene glycol increases, stability of the genotype molecule tends to increase, and in particular, the stability becomes favorable with a molecular weight of 1000 or more. If the molecular weight is 400 or less, properties thereof are not different so much from those of a DNA spacer, and it may become unstable.

The peptide acceptor region is not particularly limited, so long as it can bind to the C-terminus of peptide. For example, puromycin and 3′-N-aminoacylpuromycin aminonucleosides (PANS-amino acids) including PANS-amino acids corresponding to all amino acids such as PANS-Gly in which the amino acid portion is glycine, PANS-Val in which the amino acid portion is valine, and PANS-Ala in which the amino acid portion is alanine can be utilized. Further, 3′-N-aminoacyladenosine aminonucleosides (AANS-amino acids) in which a 3′-aminoacyladenosine and an amino acid is bonded via an amide bond as a chemical bond formed as a result of dehydration condensation of the amino group of the 3′-aminoacyladenosine and the carboxyl group of the amino acid corresponding to all amino acids, for example, AANS-Gly in which the amino acid portion is glycine, AANS-Val in which the amino acid portion is valine, AANS-Ala in which the amino acid portion is alanine, and so forth can also be used. Furthermore, nucleosides and nucleosides bound with an amino acid via an ester bond can also be used. In addition, any of substances formed with a bonding scheme that can chemically bond a nucleoside or a substance having a chemical structure similar to that of nucleoside and an amino acid or a substance having a chemical structure similar to amino acid can be used.

The peptide acceptor region is preferably comprises puromycin or a derivative thereof, or puromycin or a derivative thereof and one or two residues of deoxyribonucleotides or ribonucleotides. The term “derivative” herein used means a derivative that can bind to the C-terminus of peptide in a protein translation system. The puromycin derivative is not limited to those having the total puromycin structure, and includes those having the puromycin structure a part of which is eliminated. Specific examples of the puromycin derivative include PANS-amino acids, AANS-amino acids and so forth.

Although the peptide acceptor region may have a structure consisting of puromycin, it preferably has a nucleotide sequence comprising a DNA and/or RNA of one or more residues at the 5′ end side. As such a sequence, dC-puromycin, rC-puromycin, and so forth, more preferably, CCA sequences comprising dCdC-puromycin, rCrC-puromycin, rCdC-puromycin, dCrC-puromycin and so forth and imitating the 3′ end of aminoacyl-tRNA (Philipps, G. R. (1969) Nature 223, 374-377), are suitable. As for the type of nucleotide, preference is higher in the order of C>(U or T)>G>A.

The spacer molecule preferably contains at least one function-imparting unit between the donor region and the PEG region. The function-imparting unit preferably comprises at least one residue of deoxyribonucleotide or ribonucleotide of which base is functionally modified. As a substance for functional modification, for example, those introduced with a fluorescent substance, biotin, or any of various tags for separation such as His-tag, or the like can be used.

The coding molecule in this embodiment is a nucleic acid containing a 5′ non-translation region including a transcription promoter and a translation enhancer, an ORF region encoding a protein and binding to the 3′ end side of the 5′ non-translation region, a poly-A sequence binding to 3′ end side of the ORF region, and a 3′ end region including a sequence recognizable by the restriction enzyme XhoI on the 5′ end side thereof.

The coding molecule may be a DNA or RNA, and when it is RNA, it may or may not have a Cap structure at the 5′ end. Further, the coding molecule may be such a molecule incorporated into an arbitrary vector or plasmid.

The 3′ end region contains the XhoI sequence and the poly-A sequence downstream from the XhoI sequence. As a factor affecting the ligation efficiency of the spacer molecule and the coding molecule, the poly-A sequence in the 3′ end region is important, and the poly-A sequence is a poly-A continuous chain consisting of at least two, preferably 3 or more, more preferably 6 or more, still more preferably 8 or more, of single kind or mixed kinds of residues selected from dA and/or rA.

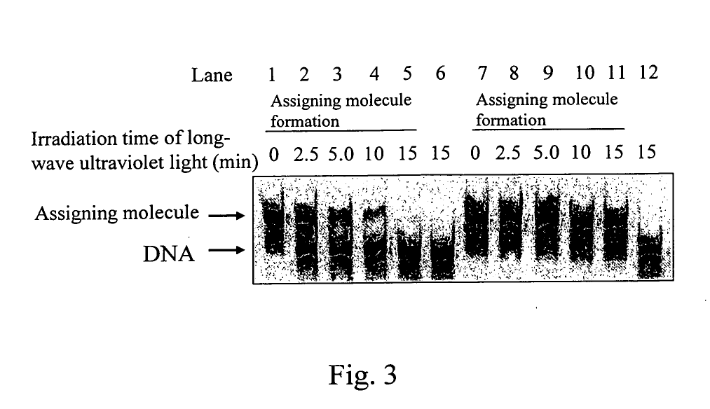

One of the factors affecting the translation efficiency of the coding molecule is a combination of the 5′ non-translation region comprising a transcription promoter and a translation enhancer and the 3′ end region including a poly-A sequence. The effect of the poly-A sequence of the 3′ end region is usually exerted with a length of ten or less residues. As the transcription promoter of the 5′ non-translation region, T7/T3, SP6, and so forth can be used, and no particular limitation is imposed. SP6 is preferred, and it is particularly preferable to use SP6, especially when an omega sequence or a part of omega sequence is used as the translation enhancer sequence. The translation enhancer is preferably a part of the omega sequence, and as the part of the omega sequence, one containing a part of the omega sequence of TMV (O29, refer to Gallie D. R., Walbot V. (1992) Nucleic Acids Res., vol. 20, 4631-4638, and WO02/48347, FIG. 3) is preferred.

Further, for the translation efficiency, the combination of the XhoI sequence and the poly-A sequence is important in the 3′ end region. Furthermore, the combination of the downstream portion of the ORF region, i.e., the upstream region of the XhoI sequence having an affinity tag, and the poly-A sequence is also important. The affinity tag sequence may be any sequence for utilizing a means that can detect a protein such as an antigen-antibody reaction, and no limitation is imposed except for this condition. The affinity tag is preferably the Flag-tag sequence, which is a tag for affinity separation analysis based on an antigen-antibody reaction. As for the effect of the poly-A sequence, an affinity tag such as the Flag-tag attached to the XhoI sequence and the tag further attached to the poly-A sequence increase the translation efficiency. Such a configuration effective for improvement of translation efficiency is also effective for assignment efficiency.

The ORF region may be any sequence comprising a DNA and/or RNA. It may be a gene sequence, exon sequence, intron sequence, random sequence, or any natural sequence or artificial sequence, and the sequence is not limited. Further, if SP6+O29 and Flag+XhoI+Aₙ (n=8) are used as the 5′ non-translation region and the 3′ end region of the coding molecule, respectively, for example, the 5′ non-translation region and the 3′ end region would have lengths of about 60 bp and about 40 bp, respectively, and thus they have such a length that they can be incorporated into a primer for PCR as an adapter region. Therefore, a coding molecule having a 5′ non-translation region and 3′ end region can be easily produced by PCR from any of vectors, plasmids and cDNA libraries. In the coding molecule, translation may occur beyond the ORF region. That is, there may not be a stop codon at the end of the ORF region.

The coding molecule in this embodiment is a nucleic acid containing a 5′ non-translation region including a transcription promoter and a translation enhancer, an ORF region encoding a protein and binding to the 3′ end side of the 5′ non-translation region, and a 3′ end region containing a poly-A sequence and binding to the 3′ end side of the ORF region.

The coding molecule constituting the genotype molecule preferably has the XhoI sequence.

The genotype molecule can be produced by converting the aforementioned coding molecule into such a form that a nucleotide sequence of the region encoding a protein can be translated (e.g., performing transcription), if necessary, and then ligating the 3′ end of the coding molecule and the donor region of the spacer molecule by means of a usual ligase reaction. The reaction conditions may usually be, for example, a reaction temperature of 4 to 25° C. and a reaction time of 4 to 48 hours. When polyethylene glycol having the same molecular weight as that of polyethylene glycol in the PEG region of the spacer molecule containing the PEG region is added to the reaction system, the reaction time may be shortened to 0.5 to 4 hours at 15° C.

The combination of the spacer molecule and the coding molecule provide an effect important for the ligation efficiency. It is preferred that the 3′ end region of the coding molecule, which corresponds to the acceptor, contains a poly-A sequence of at least 2 or more residues, preferably 3 or more residues, still more preferably 6 to 8 residues or more, of DNA and/or RNA. Furthermore, as the translation enhancer of the 5′ non-translation region, a partial sequence of the omega sequence (O29) is preferred, and as the donor region of the spacer molecule, at least 1 residue of dC (deoxycytidylic acid) or two residues of dCdC (dideoxycytidylic acid) is preferred. With these characteristics, an RNA ligase can be used to obviate the problems of DNA ligase, and the efficiency can be maintained at 60 to 80%.

It is preferred that (a) 3′ end of a coding molecule that is RNA containing a 5′ non-translation region including a transcription promoter and a translation enhancer, an ORF region encoding a protein and binding to the 3′ end side of the 5′ non-translation region, and a 3′ end region containing a poly-A sequence and binding to 3′ end side of the ORF region, and (b) a donor region of the aforementioned spacer molecule, which consists of RNA, are bound with an RNA ligase in the presence of free polyethylene glycol having the same molecular weight as that of the polyethylene glycol constituting the PEG region in the spacer molecule.

By adding polyethylene glycol having the same molecular weight as that of the polyethylene glycol constituting the PEG region in the spacer molecule during the ligation reaction, the ligation efficiency is improved to 80 to 90% or more, regardless of the molecular weight of the polyethylene glycol of the spacer molecule, and the separation process after the reaction can also be omitted.

As for the assigning molecule of this embodiment, the genotype molecule can be linked with a phenotype molecule, which is a protein encoded by the ORF region in the genotype molecule, through a transpeptidation reaction by translating the aforementioned genotype molecule in a cell-free translation system. The cell-free translation system is preferably one derived from wheat germ or rabbit reticulocyte. The conditions of the translation may be usually employed conditions. For example, the conditions may be a reaction temperature of 25 to 37° C., and a reaction time of 15 to 240 minutes.

<1-2> Cleavable Linker

The cleavable linker used for the assigning molecule of the present invention is a linker cleavable under a condition that does not change the nucleotide sequence of the nucleic acid in the coding molecule. The expression that “the nucleotide sequence of the nucleic acid does not change” means that the nucleotide sequence in the released coding molecule maintains the nucleotide sequence encoding a protein, which is a phenotype molecule of the assigning molecule, without deletion of the nucleotide sequence or alteration of a nucleotide thereof.

Examples of such a cleavable linker are shown in Table 1. In the parentheses, means for cleaving each linker are mentioned.

TABLE 1

Photocleavable linker (long-wave ultraviolet light)
DNA type linker (deoxyribonuclease, restriction enzyme)
RNA type linker (ribonuclease)
DNA/RNA hybrid type linker (ribonuclease H)
Peptide type linker (protease)
Ester bond type linker (esterase)
Disulfide bond type linker (DTT, β-mercaptoethanol)
T-(EDTA) type linker (iron ion, DTT)
Sugar chain type linker (glycolytic enzyme)
Abasic nucleotide type linker (weak base)

Because such linkers per se and cleaving methods therefor are known by those skilled in the art, it is easy for those skilled in the art to choose cleavage conditions that do not change the nucleotide sequence of the nucleic acid in the coding molecule when they are used for the assigning molecule, and to choose a means that can attain cleavage under such conditions. For example, in the case of a photocleavable linker, because a nucleic acid is damaged by irradiation of ultraviolet light of short wavelength, a linker that can be cleaved by irradiation of long-wave ultraviolet light not damaging a nucleic acid is chosen. Further, in the cases of a DNA type linker, RNA type linker and DNA/RNA hybrid type linker, type of nuclease and reaction conditions are selected so that a nucleic acid encoding a protein should not be decomposed.

In the present invention, the cleavable linker is preferably a photocleavable linker. As described above, the photocleavable linker may be one that can be cleaved by irradiation of long-wave ultraviolet light. The term “long-wave ultraviolet light” used herein means ultraviolet light having a wavelength that does not change a nucleotide sequence of a nucleic acid in the coding molecule, and it is usually ultraviolet light having a wavelength of 300 to 400 nm, preferably 310 to 360 nm. Because the photocleavable linker is unlikely to affect a bond including a specific bond between a protein and a target substance and a nonspecific bond between a target substance or solid phase and a nucleic acid, and therefore it is likely to release only a nucleic acid in a coding molecule of a specifically binding assigning molecule, the photocleavable linker is particularly preferred.

Specific examples of the photocleavable linker that can be cleaved with long-wave ultraviolet light include, for example, those having a structure of an α-substituted 2-nitrobenzyl group and so forth. Examples of the α-substituent include (i) phosphoramidite that reacts with hydroxyl group, (ii) N-hydroxysuccinimide carbonate that reacts with amino group, (iii) a halogen that reacts with thiol group and so forth. Examples of the photocleavable linker of (i) mentioned above include PC Biotin Phosphoramidite, PC Amino-Modifier Phosphoramidite, PC Spacer Phosphoramidite (all are trade names, produced by Glen Research), and so forth.

The position of the cleavable linker in the assigning molecule is not particularly limited, so long as it locates between the protein and nucleic acid in the coding molecule and cleavage thereof is possible, and it is suitably selected depending on the type of the assigning molecule and kind of cleavable linker. For example, in the case of the assigning molecule based on the STABLE method, the cleavable linker can be located between a DNA encoding a fusion protein and a ligand. Further, in the case of the assigning molecule based on the in vitro virus method, the cleavable linker may be incorporated into a spacer molecule as a constituent element, or it can be located between a spacer molecule and a coding molecule.

When the cleavable linker consists of a nucleic acid, it may be incorporated into a nucleic acid encoding a protein, and when the cleavable linker consists of a peptide, it may be fused to a C-terminus of a protein as the phenotype molecule.

<2> Production Method of the Present Invention

The assigning molecule of the present invention is produced by providing a nucleic acid encoding a protein constructed as a genotype molecule so that, when the protein is synthesized from the nucleic acid encoding the protein, i.e., when the nucleic acid is transcribed and/or translated, the protein as a phenotype molecule and the nucleic acid as the genotype molecule should be linked via a cleavable linker, and transcribing and/or translating the prepared nucleic acid using a cell-free protein synthesis system or a live cell to prepare the assigning molecule comprising the protein as the phenotype molecule and the nucleic acid as the genotype molecule linked to each other.

The cell-free protein synthesis system may be a cell-free translation system or may be a cell-free transcription and translation system, and it is suitably selected depending on the type of the nucleic acid constituting the assigning molecule.

In the case of the STABLE method, for example, the assigning molecule is produced by providing a DNA comprising the aforementioned DNA having at least a transcription and translation initiation region and a region encoding a fusion protein of a targeted protein and adapter protein, which DNA is bound with a ligand via a cleavable linker, and synthesizing a protein from the DNA in a cell-free transcription and translation system. Alternatively, proteins are synthesized by providing a library of DNAs each comprising at least a transcription and translation initiation region and a region encoding a fusion protein of a targeted protein and adapter protein, which DNA is bound with a ligand via a cleavable linker, and synthesizing proteins from DNAs in the library of DNAs in cell-free transcription and translation systems separated so that each system should contain one kind or one molecule of DNA.

Further, in the case of the assigning molecule based on the in vitro virus method, the genotype molecule may be prepared by using a spacer molecule containing a cleavable linker, binding a spacer molecule and a coding molecule via a cleavable linker, or linking a sequence encoding a cleavable linker to the 3′ end of ORF so that coding frames should be matched.

Examples of the method for producing the genotype molecule include, for example, a method of chemically synthesizing a 3′ end side of ORF of coding molecule or a spacer molecule so that it should contain a cleavable linker and then performing the method described in <1-1> (b). For the chemical synthesis, a method known per se can be suitably selected and used.

Specific examples of the method for synthesizing a coding molecule or spacer molecule containing a cleavable linker include, for example, for the case of using a cleavable linker having a structure of α-substituted 2-nitrobenzyl group and a phosphoramidite that reacts with hydroxyl group as the α-substituent, a method of introducing the linker into the 3′ end side of ORF of the coding molecule or the spacer molecule by the phosphoramidite DNA synthesis method, and so forth. Further, for the case of using a cleavable linker having a structure of α-substituted 2-nitrobenzyl group and using N-hydroxysuccinimide carbonate that reacts with amino group as the α-substituent, a method of introducing the linker into the 3′ end side of ORF of the coding molecule or the spacer molecule by the phosphoramidite DNA synthesis method and then performing modification with an active ester, and so forth are used. Furthermore, for the case of using a cleavable linker having a structure of α-substituted 2-nitrobenzyl group and a halogen that reacts with thiol group as the α-substituent, a method of introducing the linker into the 3′ end side of ORF of the coding molecule or the spacer molecule by the phosphoramidite DNA synthesis method, and so forth can be mentioned.

Further, when a DNA type linker is used, it can be produced by inserting a DNA type linker which is a nucleic acid having a nucleotide sequence recognized by a nuclease or a restriction enzyme into the 3′ end side of ORF of the coding molecule or the spacer molecule to attain the synthesis. A DNA that can be digested with a restriction enzyme needs to be double-stranded, and therefore the nucleic acid having the nucleotide sequence of the DNA linker can be produced by synthesizing each single strand one by one and annealing them.

Further, when a peptide type linker that can be cleaved with a protease is used, the coding molecule or spacer molecule can be easily produced by, for example, using the thioester method to introduce an objective peptide into the 3′ end side of ORF or spacer molecule of the coding molecule and thereby attain the synthesis.

As the live cell, cells of prokaryotes or eukaryotes such as Escherichia coli can be used.

The nucleic acid encoding a protein constructed so that, when the nucleic acid is transcribed and/or translated, the protein and the nucleic acid should be linked via a cleavable linker is preferably such a nucleic acid constructed so that, when the nucleic acid is transcribed and/or translated in a cell-free protein synthesis system, the protein and the nucleic acid should be linked via a cleavable linker. The nucleic acid encoding a protein constructed so that, when the nucleic acid is transcribed and/or translated in a cell-free protein synthesis system, the protein and the nucleic acid should be linked via a cleavable linker is considered to be similarly transcribed and/or translated even when a live cell is used as the case of using a cell-free protein synthesis system.

The assigning molecule obtained by transcription and/or translation using a cell-free protein synthesis system or a live cell may be purified as required.

The library of assigning molecules of the present invention can be produced by applying the aforementioned production method of the present invention to collection of DNAs in a nucleic acid library, that is, each nucleic acid in the nucleic acid library.

<3> Screening Method of the Present Inventions

The screening method of the present invention is a method for screening a nucleic acid library for a nucleic acid encoding a protein that interacts with a target substance, and comprises the step of producing a library of assigning molecules from the nucleic acid library by the production method of the present invention, the step of mixing the library of assigning molecules and the target substance, the step of separating an assigning molecule binding to the target substance, the step of cleaving a linker of the separated assigning molecule under a condition that does not change a nucleotide sequence of the nucleic acid to release the nucleic acid, and the step of collecting the released nucleic acid.

Examples of the target substance include a protein (including peptide, antibody etc.), nucleotide, and so forth. The interaction can be measured by a method suitable for the type of the target substance (for example, Rigaut, G. et al. (1999) Nature Biotech. 17, 1030-1032).

As for the mixing of a library of assigning molecules and a target substance, they can be mixed under such a condition that the targeted protein of assigning molecules should interact with the target substance. This condition is suitably chosen according to the types of the interaction to be detected and target substance.

The separation of the assigning molecule binding to the target substance corresponds to a step of separating assigning molecules binding to the target substance and assigning molecules not binding to the target substance, and the separation can usually be attained by using the target substance immobilized on a solid phase and washing the solid phase on which the target molecules are immobilized after mixing with the assigning molecules. The conditions for the washing are suitably chosen according to the types of the interaction and target substance to be detected. The expression of “to immobilize on a solid phase” used herein means that the bound assigning molecule and target substance are in a state that they can be separated from unbound molecules, and when the target substance is a membrane protein, for example, a membrane protein expressed on cell membrane of a cell or the like and a protein embedded in an artificial membrane are also included in the concept of the target substance immobilized on a solid phase.

The linker of the separated assigning molecule can be cleaved under a condition that does not change the nucleotide sequence of the nucleic acid to release the nucleic acid by using such a cleavable linker as exemplified above under a condition suitable for it. When the target substance is immobilized on a solid phase, releasing the nucleic acid is also called “elution”. In the present invention, the term “release” is used for a meaning including “elution”. Further, the nucleic acid to be released may be modified so long as the nucleotide sequence of the nucleic acid can be analyzed.

The released nucleic acid can be collected by a usual method. Examples include, for example, a method of collecting it by electrophoresis, a method of precipitating components other than the released nucleic acid and collecting a supernatant, and so forth.

The collected nucleic acid may be subjected to amplification and sequence analysis depending on the purpose of functional analysis, evolutionary engineering and so forth.

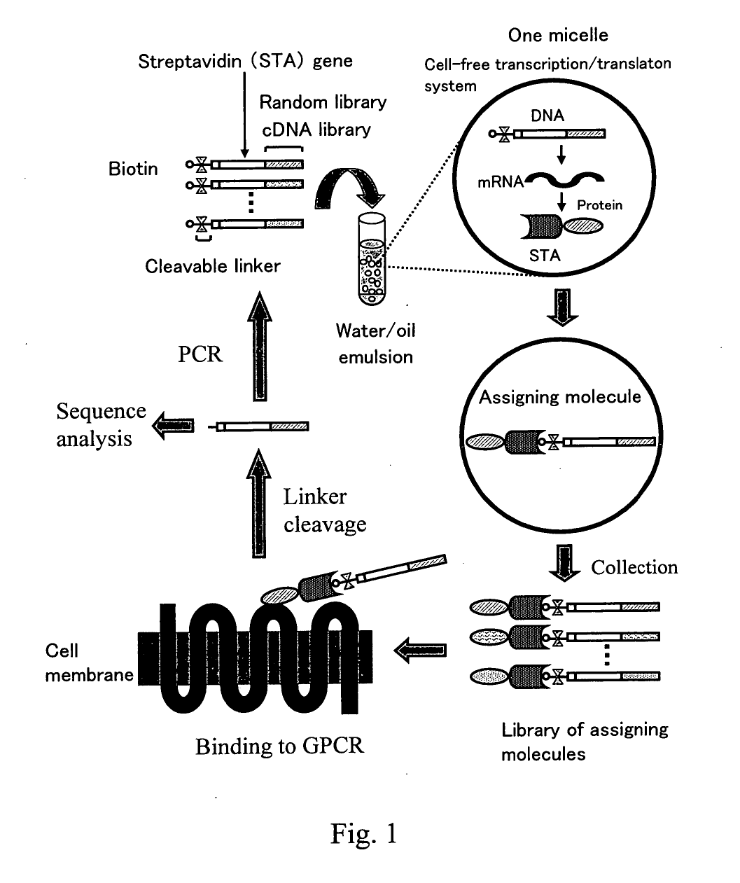

Hereafter, an example of the screening will be explained with reference to FIG. 1. In this example, the G-protein coupled receptor (GPCR) is used as the target substance, and an assigning molecule based on the STABLE method is used as the assigning molecule (the ligand is biotin, and the adapter protein is streptavidin).

First, with each DNA constituting a DNA library such as random library and cDNA library, a streptavidin gene is linked so that streptavidin and a protein encoded by the DNA should be expressed as a fusion protein, and biotin is further linked via a cleavable linker to prepare a DNA modified so that, when such a protein mentioned above is synthesized from the DNA in a cell-free transcription and translation system, the protein and the DNA should be linked via a cleavable linker.

The modified DNA is transcribed and translated in a cell-free transcription and translation system as a water/oil type emulsion prepared so that about 1 molecule of DNA should be contained in one micelle to synthesize a fusion protein. Thus, streptavidin as a constituent of the fusion protein and biotin as a constituent of the modified DNA are bound to form an assigning molecule.

Assigning molecules are collected from the emulsion to obtain a library of assigning molecules. The assigning molecules are mixed with cells expressing GPCR on the cell membranes. DNAs are released by cleaving the linker and collected.

Depending on the purpose, the collected DNA can be subjected to sequence analysis, or amplified by PCR, bound again with biotin via a cleavable linker, and used for repeating the aforementioned step.

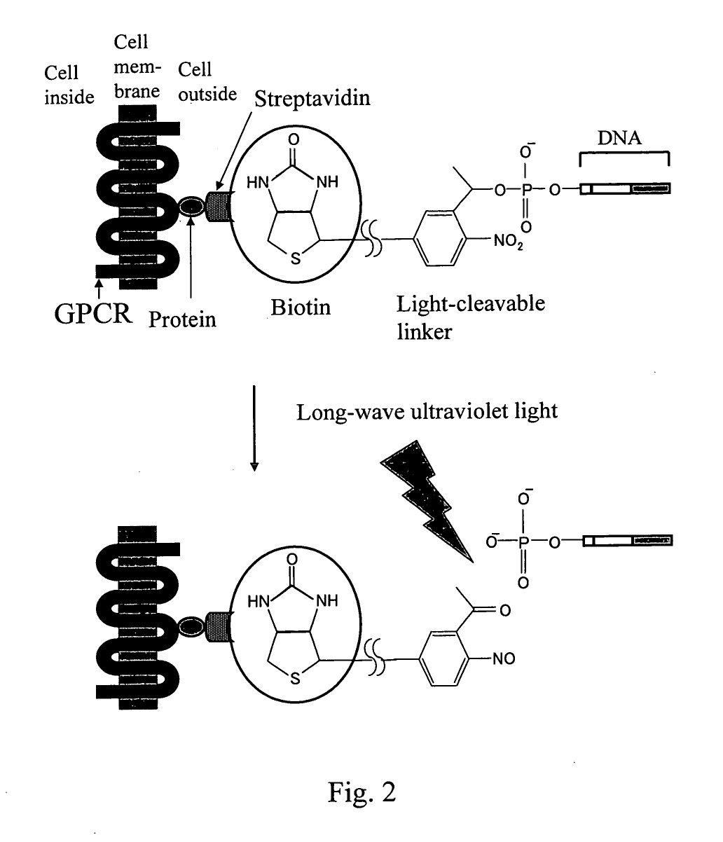

Hereafter, an example of cleavage of a cleavable linker will be explained with reference to FIG. 2. In this example, a cleavable linker photocleavable with long-wave ultraviolet light is used as the cleavable linker in the example shown in FIG. 1.

The upper drawing of FIG. 2 represents a state of an assigning molecule binding to GPCR as a target substance. If long-wave ultraviolet light that cleaves the photocleavable linker is irradiated on the assigning molecule binding to GPCR, DNA is released as shown in the lower drawing of FIG. 2.

### EXAMPLES

Hereafter, examples of the present invention will be specifically described. However, the following examples should be considered mere help for concretely understanding the present invention, and the scope of the present invention is no way limited by the following examples.

### Example 1

### Cleavage of Assigning Molecule Containing Photocleavable Linker with Ultraviolet Light

A molecule comprising a DNA and a protein linked with each other via a photocleavable linker was formed, and then it was confirmed that the DNA and the protein were cleaved and separated by irradiation of long-wave ultraviolet light. Although the molecule comprising a DNA and a protein linked with each other used in this example did not contain a protein encoded by the DNA, it is considered that the molecule exhibits the same behavior as that of an assigning molecule for the cleavage with the ultraviolet light, and therefore the molecule is called assigning molecule for convenience of explanation.

(1) Preparation of DNA Labeled with Biotin Via Photocleavable Linker

Biotin bound with a photocleavable linker (Photocleavable Biotin, abbreviated as “PCB” hereinafter) was purchased from Glen Research. sta-atii DNA (SEQ ID NO: 1) comprising the streptavidin gene fused with the angiotensin II gene on the downstream side of the streptavidin gene was prepared as a template DNA. A reaction mixture in a volume of 50 μl containing 0.5 nM of the template DNA (SEQ ID NO: 1), 1 μM of primer T7F (SEQ ID NO: 2) of which 5′ end was labeled with PCB, 1 μM of primer T7R (SEQ ID NO: 3) of which 5′ end was labeled with fluorescein, 1×Ex Taq buffer, 0.2 mM of dNTP and 1.25 U of Ex Taq DNA polymerase (Takara Shuzo) was used to perform PCR (95° C. for 1 minute->(98° C. for 20 seconds, 62° C. for 30 seconds, 72° C. for 30 seconds)×25 cycles->72° C. for 1 minute->4° C.). By this procedure, a DNA labeled with fluorescein and PCB (it is abbreviated as “PCB-labeled DNA” hereafter) was obtained. In a similar manner, a DNA labeled with biotin and fluorescein and containing no photocleavable linker (abbreviated as “biotin-labeled DNA” hereafter) was prepared as a negative control by using the primer T7F labeled with biotin at the 5′ end.

(2) Formation of Assigning Molecule and Cleavage thereof by Irradiation of Long-Wave Ultraviolet Light

Equal amounts of the aforementioned PCB- or biotin-labeled DNA (30 nM) and streptavidin (1 μg/μl, Promega) were mixed and bound by incubation at room temperature for 60 minutes to form an assigning molecule comprising the protein and the DNA linked with each other. A sample was irradiated with long-wave ultraviolet light from a distance of 15 cm by using an ultraviolet lamp (Handy Lamp XX-15 BLB, Ultra-Violet Products) for 2.5 minutes, 5 minutes, 10 minutes or 15 minutes, and separated by electrophoresis in 3% SeaKem Gold agarose gel, and fluorescence of the fluorescein was detected by using an image analyzer. The results are shown in FIG. 3. When the PCB-labeled DNA was used, the bands detected as assigning molecules of a high molecular weight (at the position indicated with “Assigning molecule->” in the drawing) shifted to the bands of a lower molecular weight (at the position indicated with “DNA->” in the drawing) depending on the irradiation time of long-wave ultraviolet light (Lanes 1 to 5). On the other hand, in the case of using the biotin-labeled DNA containing no photocleavable linker, the shift from high molecular weight to low molecular weight was not seen at all (Lanes 7 to 11). On the basis of these results, it could be confirmed that the photocleavable linker in the assigning molecule was cleaved by long-wave ultraviolet light, and thus the DNA as a genotype molecule was released from the assigning molecule.

### Example 2

### Synthesis of Assigning Molecule utilizing GPCR Ligand Peptide in Cell-Free Transcription and Translation System

Angiotensin II known as a ligand of GPCR was used to form an assigning molecule. The fluorescein- and PCB-labeled sta-atii DNA (prepared in Example 1) were added at 9 nM to a cell-free transcription and translation system derived from rabbit reticulocytes (Promega) and incubated at 30° C. for 90 minutes to synthesize a streptavidin/angiotensin II fusion protein (abbreviated as “STA-AT II” hereafter) and thereby form an assigning molecule comprising the protein and sta-atii DNA linked via the binding of streptavidin and biotin. This sample was separated by electrophoresis in 3% SeaKem Gold agarose gel, and fluorescence of fluorescein was detected by using an image analyzer. Further, a control experiment was performed by adding 0.2% of heparin as a protein synthesis inhibitor.

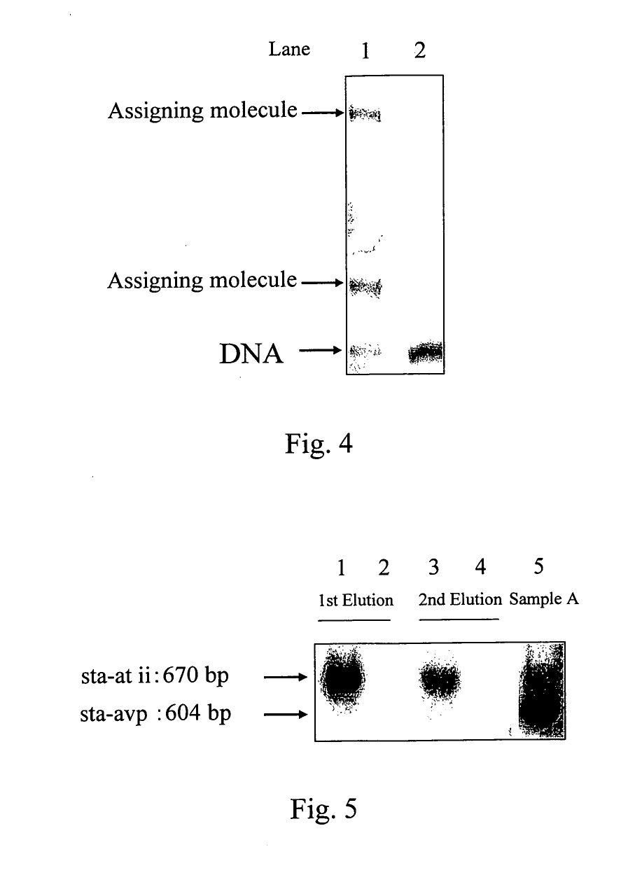

The detection results of the STA-AT II assigning molecule synthesized in the cell-free transcription and translation system are shown in FIG. 4. When heparin, which is a protein synthesis inhibitor, was added, the streptavidin/angiotensin II fusion protein was not synthesized, and therefore only the band of the fluorescein- and PCB-labeled sta-atii DNA (at the position indicated with “DNA->” in the drawing) was detected (Lane 2). On the other hand, when heparin was not added, the synthesized streptavidin/angiotensin II fusion protein bound to the PCB-labeled sta-atii DNA, and therefore a band shifted to the high molecular weight side (at the position indicated with “Assigning molecule->” in the drawing) was detected (Lane 1). On the basis of these results, formation of the assigning molecule by protein synthesis in the cell-free transcription and translation system using the PCB-labeled DNA as a template DNA could be confirmed. The assignment efficiency (ratio of DNA that formed the assigning molecule to the total DNA added to the cell-free transcription and translation system) was about 80%.

### Example 3

### Ligand Enrichment Experiment using GPCR Expressing Cells

The enrichment experiment of the STA-AT II assigning molecule was conducted by using the CHO-K1 cells expressing human angiotensin II type 1 receptor (this receptor is abbreviated as “hAT1R” hereafter, and the CHO-K1 cells expressing hAT1R are abbreviated as hAT1R/CHO-K1 cells hereafter).

(1) Preparation of DNA Labeled with Biotin via Photocleavable Linker

In the same manner as in Example 1, PCB-labeled sta-atii DNA (total length: 670 bp) was obtained. Further, PCR was performed in the same manner by using a template DNA (SEQ ID NO: 4) encoding vasopressin that does not bind with hAT1R instead of angiotensin II to obtain a PCB-labeled sta-avp DNA (total length: 604 bp) as a negative control.

(2) Formation of Assigning Molecule

The PCB-labeled sta-atii DNA was added at 10 nM to a cell-free transcription and translation system derived from rabbit reticulocytes and incubated at 30° C. for 90 minutes to synthesize a streptavidin/angiotensin II fusion protein and thereby form a STA-AT II assigning molecule. In a similar manner, a streptavidin/vasopressin fusion protein (abbreviated as “STA-AVP” hereafter) was synthesized by using 10 nM of PCB-labeled sta-avp DNA as a template, and thereby an assigning molecule comprising the protein and the sta-avp DNA was formed. To a cell-free transcription and translation system containing each of these assigning molecules, an equal amount of 20 μM biotin was added and reacted for 15 minutes to block the excessive biotin-binding sites. Then, the systems were mixed so that the ratio of STA-AT II:STA-AVP should become 2.4×10⁸:1.2×10⁹=1:5 and used for the enrichment experiment of (4) described below.

(3) Establishment of Cell Line Stably Expressing hAT1R

In order to clone the hAT1R gene, 0.05 μl of a human fetal liver cDNA library (provided by Professor Junichiro Inoue, Keio University) was mixed with 5 μl of 10×Ex Taq buffer, 4 μl of 2.5 mM dNTP, 2.5 μl of 10 μM ATF primer (SEQ ID NO: 5), 2.5 μl of 10 μM ATR primer (SEQ ID NO: 6), and 0.25 μl of 5 U/μl Ex Taq DNA polymerase, adjusted to a total volume of 50 μl with sterilized water, and used to perform PCR (95° C. for 1 minute->(98° C. for 20 seconds, 55° C. for 1 minute, 72° C. for 4 minutes)×35 cycles->4° C.) to obtain a hAT1R gene fragment. This hAT1R gene fragment was treated with the restriction enzymes EcoRI and XbaI and ligated to similarly treated pEF1/Myc-His A (Invitrogen) to obtain pEF1-hAT1R-MycHis (neomycin resistance). This pEF1-hAT1R-MycHis was transfected into the CHO-K1 cells and selection was conducted in a medium containing 400 μg/μl of G418 to obtain CHO-K1 cells expressing hAT1R which was confirmed by Western blotting using an antibody against the Myc epitope.

(4) Binding and Enrichment Experiment using Cells

First, the following pretreatment was performed in order to remove assigning molecules nonspecifically adsorbed on cell surfaces. After CHO-K1 cells not expressing the receptor (abbreviated as “Mock/CHO-K1 cells” hereafter) were cultured to a confluent state in a 6-cm dish, the complete medium in the dish was removed by suction, and 2 ml of Hank's balanced salt solution (abbreviated as “HBSS” hereafter) was added to wash the inside of the dish. A binding buffer (100 μM GRGDS (SEQ ID NO: 7), 1 mg/ml of sonicated salmon sperm DNA, and 1% BSA/basic buffer) in a volume of 1 ml was added to the dish and shaken at room temperature for 15 minutes (50 rpm) by a shaker for blocking. The basic buffer had a composition of 1% protease inhibitor cocktail, 0.5 M sucrose, 20 mM HEPES, pH 7.3, and HBSS. After the binding buffer was removed by suction, 1 ml of Sample A obtained by adding the assigning molecules STA-AT II and STA-AVP prepared in (2) described above at a ratio of 2.4×10⁸:1.2×10⁹ and 40 μl of the transcription and translation system derived from rabbit reticulocytes to the binding buffer was added to the Mock/CHO-K1 cells and shaken at room temperature for 60 minutes (50 rpm) by a shaker to complete the pretreatment.

After the pretreatment, Sample A was transferred to a 1.5-ml tube and centrifuged at 2,000 rpm for 1 minute, and 1 ml of the supernatant was added to the hAT1R/CHO-K1 cells blocked in a similar manner. The dish was shaken (50 rpm) at room temperature for 60 minutes by a shaker for binding, and then Sample A was removed by suction. For washing, 3 ml of a washing buffer (450 mM NaCl, 10 μM GRGDS (SEQ ID NO: 7), 100 μg/ml of sonicated salmon sperm DNA/basic buffer) was added to perform washing, and the washing buffer was removed by suction. This washing procedure was performed 6 times. For elution, 1 ml of an elution buffer (100 μM GRGDS (SEQ ID NO: 7), 0.5 μg/ml of sonicated salmon sperm DNA/basic buffer) was added to the dish, and the dish was placed on ice after the lid thereof was removed and irradiated with long-wave ultraviolet light for 5 minutes under the same conditions as those used in Example 1. The supernatant was collected in a 1.5-ml tube and subjected to the elution procedure twice. The solution obtained after the elution was subjected to ethanol precipitation, and the pellet was dried and dissolved in 25 μl of purified water (milli-Q water). This eluted sample in a volume of 1 μl, 0.25 μl each of 100 μM primers T7F and T7R, 2.5 μl of 10×Ex Taq buffer, 2 μl of 2.5 mM dNTP and 0.125 μl of 5 U/pl Ex Taq DNA polymerase were mixed and adjusted to a total volume of 25 μl with sterilized water and used to perform PCR (95° C. for 1 minute->(98° C. for 20 seconds, 62° C. for 30 seconds, 72° C. for 30 seconds)×30 cycles→72° C. for 1 minute->4° C.). After completion of PCR, the reaction mixture was subjected to electrophoresis on 2% agarose gel, and DNA was detected. As a positive control, PCR was performed by using 10,000-fold dilution of Sample A as a template, and DNA was detected similarly. Further, as a negative control, the same procedure as used for the hAT1R/CHO-K1 cells was performed also for the Mock/CHO-K1 cells, and DNA was detected.

The results are shown in FIG. 5. When hAT1R and the STA-AT II assigning molecule are bound, the sta-atii DNA is released due to photocleavage upon irradiation of long-wave ultraviolet light, and therefore the band of 670 bp (at the position indicated with “sta-atii DNA->” in the drawing) is detected. When the STA-AVP assigning molecule that does not bind to hAT1R is nonspecifically adsorbed and eluted, the band of the sta-avp DNA (total length: 604 bp, at the position indicated with “sta-avp DNA->” in the drawing) is detected. Sample A contained the assigning molecules of STA-AT II and STA-AVP at a ratio of 1:5, and when PCR was performed by using Sample A as a template, the sta-atii DNA and sta-avp DNA were detected at a ratio of 1:5 (Lane 5). When the experimental procedure was conducted by using the hAT1R/CHO-K1 cells, and first elution and second elution were conducted by ultraviolet irradiation and photocleavage, the sta-atii DNA and sta-avp DNA were detected at a ratio of 10:1 and 4:1 (Lanes 1 and 3). The enrichment efficiency calculated on the basis of the measured intensities of the detected bands was about 50 times. On the other hand, when the experimental procedure was conducted by using the Mock/CHO-K1 cells, and first elution and second elution were conducted by ultraviolet irradiation and photocleavage, the sta-atii DNA and sta-avp DNA were not detected as expected (Lanes 2 and 4). The results described above demonstrated that the sta-atii DNA can be specifically recovered from the STA-AT II assigning molecule with high efficiency by the elution method based on photocleavage by irradiation of long-wave ultraviolet light using the hAT1R/CHO-K1 cells.

### INDUSTRIAL APPLICABILITY

According to the present invention, screening for an assigning molecule that specifically binds to a target substance can be conducted with high efficiency.

1. An assigning molecule comprising a protein and a nucleic acid encoding the protein linked to each other via a linker cleavable under a condition that does not change a nucleotide sequence of the nucleic acid.

2. The assigning molecule according to claim 1, wherein the linker is a linker cleavable with long-wave ultraviolet light.

3. A library of assigning molecules, each of which is the assigning molecule as defined in claim 1.

4. A method for producing the assigning molecule as defined in claim 1, which comprises providing a nucleic acid encoding a protein constructed so that, when the nucleic acid is transcribed and/or translated, the protein and the nucleic acid is linked and transcribing and/or translating the prepared nucleic acid using a cell-free protein synthesis system or a live cell to prepare the assigning molecule comprising the protein and the nucleic acid linked to each other,
wherein the nucleic acid is constructed so that, when the nucleic acid is transcribed and/or translated, the protein and the nucleic acid is linked via a linker cleavable under a condition that does not change a nucleotide sequence of the nucleic acid.

5. The method for producing a library of assigning molecules, which comprises producing the assigning molecules from nucleic acids constituting a nucleic acid library by the method as defined in claim 4.

6. A method for screening a nucleic acid library for a nucleic acid encoding a protein that interacts with a target substance, which comprises:
the step of producing a library of assigning molecules from the nucleic acid library by the method as defined in claim 5,
the step of mixing the library of assigning molecules and the target substance,
the step of separating an assigning molecule binding to the target substance,
the step of cleaving a linker of the separated assigning molecule under a condition that does not change a nucleotide sequence of the nucleic acid to release the nucleic acid, and
the step of collecting the released nucleic acid.

7. A library of assigning molecules, each of which is the assigning molecule as defined in claim 2.
